(19) United States
(12) Patent Application Publication
(10) Pub. No.: US 2004/0001145 A1
(43) Pub. Date: Jan. 1, 2004

(54) Method and apparatus for multifield image generation and processing

(76) Inventor: Jeffrey A. Abbate, Beaverton, OR (US)

Correspondence Address: John P. Ward, BLAKELY, SOKOLOFF, TAYLOR & ZAFMAN LLP, Seventh Floor, 12400 Wilshire Boulevard, Los Angeles, CA, 90025-1026, US

(21) Appl. No.: 10/184,535

(22) Filed: Jun. 27, 2002

(51) Int. Cl. H04N 5/225

(52) U.S. Cl. 348/207.99

(57) ABSTRACT

A method and apparatus for multifield image generation and processing. A camera includes a plurality of lenses configurable in a plurality of distinct directions, each lens to focus a scene from one of the plurality of distinct directions. A plurality of image sensor areas collect charge fields of the scenes focused by the plurality of lenses. Processing logic coupled with the plurality of image sensor areas process independent digital images for each of the plurality of image sensor areas. Processing may comprise rotational compensation, digital zooming, resampling, Moiré filtering, and/or concurrent displaying of the independent images.

### FIELD OF THE DISCLOSURE

This disclosure relates generally to the field of image generation and processing. In particular, the disclosure relates to generation of multiple images in a camera and to processing of said multiple images.

### BACKGROUND OF THE DISCLOSURE

A typical camera generates a single image or a sequence of single images. A still camera, for example typically photographs or captures an image each time a user presses a button or otherwise triggers the initiation of a photograph. A motion-picture or video camera, on the other hand typically photographs or captures a sequence of discrete images at a fixed rate, usually ten or more images per second, to generate an illusion of continuous motion. Such cameras may comprise one or more image sensors for digitally capturing an image or sequence of images, and may use internal or external systems to digitally process the captured image or sequence of images. The one or more image sensors may capture a black-and-white image or may capture a color image, each of the one or more sensors capturing at least one color component of the color image.

One variation on such cameras includes stereoscopic image capture, in which two views of the image are captured from viewpoints that are spatially displaced from one another in order to recreate, in the viewer, a perception of depth. Other variations may include more than two viewpoints to generate a higher-dimensional (more than two) image representation. Such higher-dimensional images may be captured using a single specialized camera or multiple cameras coordinated to simultaneously capture the same image. Viewing the image may require stereo goggles, polarized glasses, or a specialized projection system.

Yet another variation includes panoramic image capture, in which one or more fields of view, each from substantially the same viewpoint, may be combined into one image of a relatively large viewing angle. Other variations may include horizontal viewing angles of substantially 360 degrees, high-definition wide-screen digital video composed of one or more layers of two-dimensional field arrays, or omnidirectional viewing angles substantially from the center of an image sphere. Such large-angle images may be captured by various systems, for example, fish-eye lenses, multiple ommatidium image sensors, or omnimax camera systems. Some such systems may be rather complex and expensive. Viewing of large angle images may require projection of the image onto a two dimensional circle or rectangle with some distortion or projection of the image onto a spherical or cylindrical viewing surface.

One disadvantage associated with such camera systems is that essentially one image is produced. While elaborate camera systems may include multiple sensors, multiple lenses, and even multiple cameras, they are typically combined to affect the capture of a single image. In order to photograph or to monitor another object or event the camera must be turned away from the current object or event and focused in the direction of the new object or event.

### BRIEF DESCRIPTION OF THE DRAWINGS

The present invention is illustrated by way of example and not limitation in the figures of the accompanying drawings.

FIG. 1 illustrates one embodiment of an apparatus for multifield image generation and processing.

FIG. 2a illustrates, in detail, one alternative embodiment of an apparatus for multifield image generation and processing.

FIG. 2b illustrates, in detail, another alternative embodiment of an apparatus for multifield image generation and processing.

FIG. 3 illustrates a flow diagram for one embodiment of a process to rotationally compensate an image.

FIG. 4 illustrates, one alternative embodiment of a camera for multifield image generation and processing.

FIG. 5a illustrates one embodiment of a multifield image viewing system.

FIG. 5b illustrates an alternative embodiment of a multifield image viewing system.

FIG. 6 illustrates a flow diagram for one alternative embodiment of a process to independently rotate and zoom multifield images.

FIG. 7 illustrates, an alternative embodiment of a camera for multifield image generation and processing.

FIG. 8 illustrates an alternative embodiment of an apparatus for multifield image generation and processing.

FIG. 9a illustrates, in detail, another alternative embodiment of an apparatus for multifield image generation and processing.

FIG. 9b illustrates, in detail, another alternative embodiment of an apparatus for multifield image generation and processing.

FIG. 10 illustrates a flow diagram for one embodiment of a process to zoom and optionally resample an image.

FIG. 11 illustrates, another alternative embodiment of a camera for multifield image generation and processing.

FIG. 12a illustrates, in detail, one embodiment of the camera of FIG. 11.

FIG. 12b illustrates, in detail, another alternative embodiment of an apparatus for multifield image generation and processing.

FIG. 13 illustrates another alternative embodiment of a system for multifield image generation, processing and viewing.

FIG. 14 illustrates a flow diagram for an alternative embodiment of a process to rotationally compensate and optionally filter an image.

### DETAILED DESCRIPTION

These and other embodiments of the present invention may be realized in accordance with the following teachings and it should be evident that various modifications and changes may be made in the following teachings without departing from the broader spirit and scope of the invention. The specification and drawings are, accordingly, to be regarded in an illustrative rather than restrictive sense and the invention measured only in terms of the claims and their equivalents.

Disclosed herein is a method and apparatus for multifield image generation and processing. For one embodiment of a camera, a plurality of lenses are configured in a plurality of distinct directions, each lens to focus a scene from one of the plurality of distinct directions. A plurality of image sensor areas collect charge fields of the scenes focused by the plurality of lenses. For one embodiment of processing logic operationally coupled with the plurality of image sensor areas, an independent image is processed for each of the plurality of image sensor areas. Processing may include but is not limited to rotational compensation, digital zooming, resampling, Moiré filtering, and/or concurrent displaying of the independent images.

For the purpose of the following discussion of embodiments of the present invention, illustrative terms are used. Definitions for certain such illustrative terms follows.

A lens may include any one of a variety of devices for focusing, filtering, magnifying, distorting or adjusting images. Examples include but are not limited to any combinations of one or more of the following: a convex lens, a concave lens, a concave-convex lens, a compound lens, an objective lens, a wide angle lens, a telephoto lens, a polarizing lens, a grating, a mirror, or a prism.

An image sensor or collector may include any one of a variety of devices for capturing, recording, sensing, transmitting or broadcasting images. Examples include but are not limited to any combinations of one or more of the following: a charged couple device (CCD) sensor, a combinational metal oxide semiconductor (CMOS) sensor, a photographic film, an antenna, a device for spatial-to-frequency domain transformation, or a photographic or holographic plate.

An image guide may include any one of a variety of devices for routing, redirecting, reflecting, refracting, diffracting or convolving light rays of images. Examples include but are not limited to any combinations of one or more of the following: fiber optics, prisms, mirrors, rod lenses, spacers, etalons, interferometers, apertures or refractors.

Processing logic may include any one of a variety of articles comprising dedicated hardware or software or firmware operation codes executable by general purpose machines or by special purpose machines or by a combination of both. Examples include but are not limited to any combinations of one or more of the following: micro-controllers, digital signal processors (DSPs), application-specific integrated circuits (ASICs), computers; game systems, personal digital assistants, telephone/fax devices, video recorders, printers, or televisions.

A display monitor or monitor may include any one of a variety of devices for displaying data, images, icons, etc. It may comprise a continuous or discontinuous, flat, curved or flexible display surface including but not limited to a combination of one or more of the following technologies: liquid crystal with amorphous silicon thin-film transistor, metal-insulator-metal, or polysilicon thin-film transistor active matrix displays or liquid crystal with color super-twist nematic, double-layer supertwist nematic, high performance addressing, or dual scan passive matrix displays; back lit displays; electroluminescent displays; gas plasma displays; plasma addressed liquid crystal displays; digital visual interface displays; field emission displays; photographic paper or film development systems; projection displays; cathode ray tube displays; thin cold cathode displays; organic light-emitting diode displays; light-emitting polymer displays; touch screen displays using multi-wire resistive, surface wave, touch-on-tube, or infrared touch sensing; interlaced or progressive scanned displays; heads-up displays; back-projecting displays; or holographic autostereoscopic displays.

It will be appreciated that the invention may be modified in arrangement and detail by those skilled in the art without departing from the principles of the present invention within the scope of the accompanying claims and their equivalents.

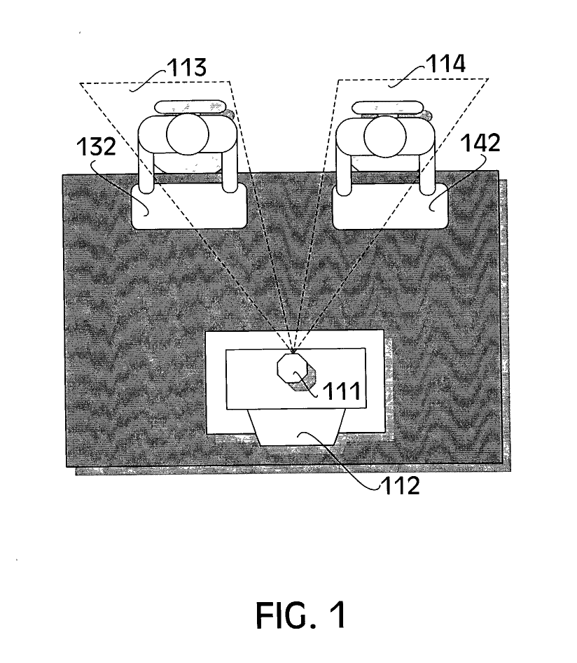

Turning now to FIG. 1, one embodiment of an apparatus for multifield image generation and processing includes a camera 111 and processing logic 112. Camera 111 comprises a lens portion directed at field of view 113 and a lens portion directed at field of view 114. A charge image of field of view 113 is collected in camera 111 and transferred to processing logic 112. A charge image of field of view 114 is also collected in camera 111 and transferred to processing logic 112. Processing logic 112 generates independent digital images from the charge fields stores the independent images separately for analysis and display.

Processing logic 112 may comprise, for example, a game system with a split display, and speech and or pattern recognitions software for analysis of independent video image streams, one for field of view 113 and one for field of view 114. A user positioned in field of view 113 may have further interaction with processing logic 112 through an interface device 132. Another user positioned in field of view 114 may also have further interaction with processing logic 112 through an interface device 142.

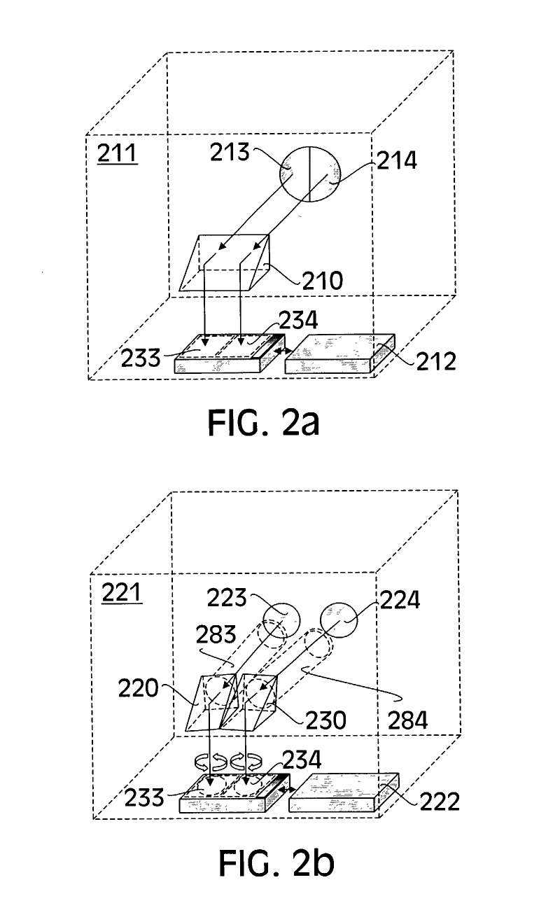

FIG. 2a illustrates, in detail, one alternative embodiment of an apparatus 211 for multifield image generation and processing. Apparatus 211 includes lens portion 213 directed at one field of view and lens portion 214 directed at another field of view. Image sensor area 233 collects a charge field of the first field of view from lens portion 213. Image sensor area 234 collects a charge field of the second field of view from lens portion 214. Apparatus 211 optionally includes one or more image guides, for example, prism 210 to direct the first field of view from lens portion 213 to sensor area 233, and to direct the second field of view from lens portion 214 to sensor area 234. Processing logic 212 is coupled with image sensor areas 233 and 234 to generate an independent digital images from the charge fields collected by sensor areas 233 and 234.

FIG. 2b illustrates, in detail, another alternative embodiment of an apparatus 221 for multifield image generation and processing. Apparatus 221 includes lens portion 223 directed at one field of view and lens portion 224 directed at another field of view. Image sensor area 233 collects a charge field of the first field of view from lens portion 223. Image sensor area 234 collects a charge field of the second field of view from lens portion 224. Apparatus 221 optionally includes one or more image guides pivotally displaceable about sensor areas 233 and 234. For example, prism 220 is physically coupled with or optically coupled with lens portion 213 through pivotally displaceable path 283 to direct the first field of view from lens portion 213 to sensor area 233, and prism 230 is physically coupled with or optically coupled with lens portion 214 through pivotally displaceable path 284 to direct the second field of view from lens portion 214 to sensor area 234. Processing logic 222 is coupled with image sensor areas 233 and 234 to generate independent digital images from the charge fields collected by sensor areas 233 and 234. The generation of each independent digital image by processing logic 222 may optionally include rotational compensation of the respective charge field.

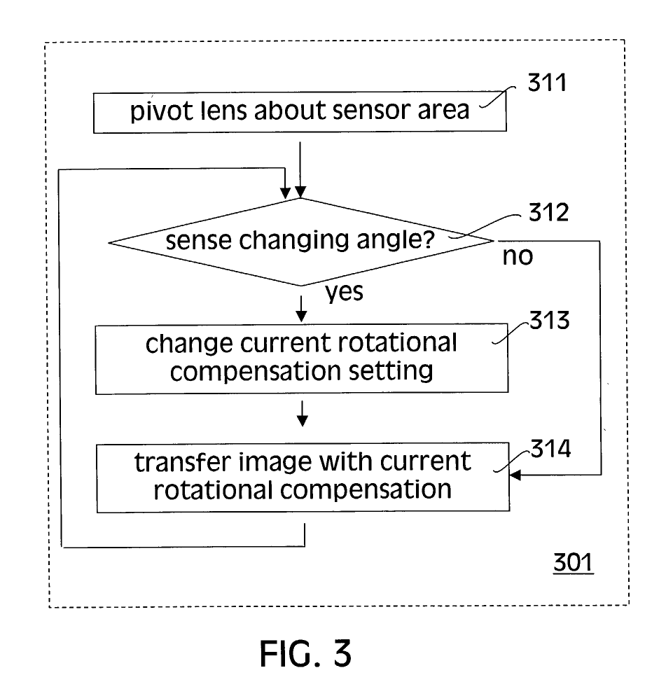

FIG. 3 illustrates a flow diagram for one embodiment of a process 301 to rotationally compensate an image. Process 301 and other processes herein disclosed are performed by processing blocks that may comprise dedicated hardware or software or firmware operation codes executable by general purpose machines or by special purpose machines or by a combination of both.

In processing block 311 a lens is pivoted (manually or mechanically) about a sensor area. In processing block 312, a changing of the angle for a field of view is potentially sensed. If a change of angle is sensed processing continues in processing block 313 where the current rotational computation setting is changed and processing continues in processing block 314 where an image is transferred with the new rotational setting. Otherwise, if no change of angle is sensed, processing continues in processing block 314 where the image is transferred with the original rotational setting.

One example of a technique for rotational compensation of a line of pixels is a variant of the Bresenham line-drawing algorithm given by Braccini and Marino (Braccini, Carlo and Giuseppe Marino, “Fast Geometrical Manipulations of Digital Images,” Computer Graphics and Image Processing, vol. 13, pp. 127-141, 1980). A horizontal line is rotated by an angle to generate a straight line having a slope n/m according to the following multiplication by a scalar and a matrix:

$$\frac{m}{\sqrt{( {n}^{2} + {m}^{2} )}} [ \begin{matrix}1 & n / m \\ - ( n / m ) & 1\end{matrix} ]$$

Other techniques for rotational compensation may be found in Wolberg, George, Digital Image Warping, 3^{rd} Edition, IEEE Computer Society Press, Los Alamitos, CA, pp. 205-214, 1994.

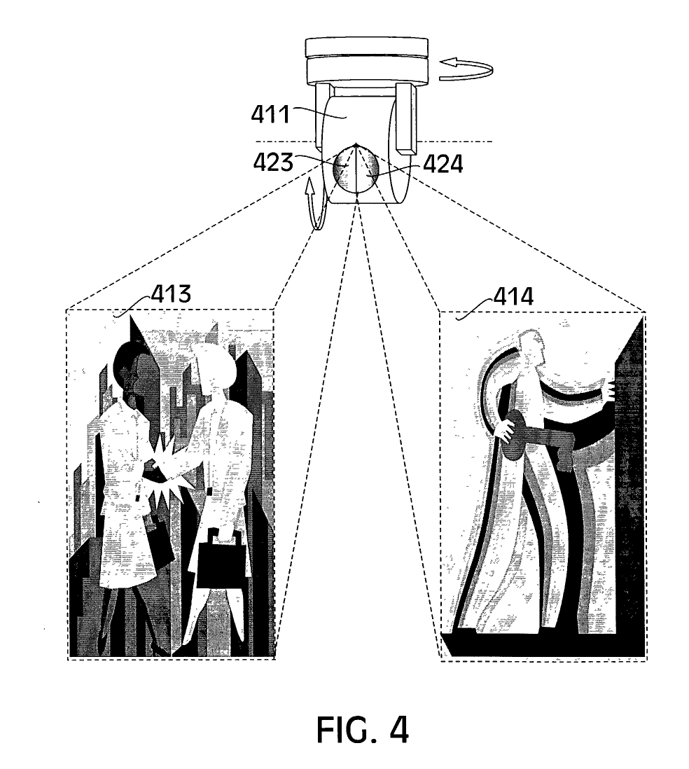

FIG. 4 illustrates, one alternative embodiment of a camera 411 for multifield image generation and processing. Camera 411 comprises lens portion 423 directed at field of view 413 and lens portion 424 directed at field of view 414. A charge image of field of view 413 is collected in camera 411 and transferred to internal or external processing logic. A charge image of field of view 414 is also collected in camera 411 and transferred to internal or external processing logic. Camera 411 may be a security camera for monitoring field of view 413 and field of view 414 from a secured area. Independent images generated for field of view 413 and field of view 414 may be processed and viewed at a location remote to camera 411.

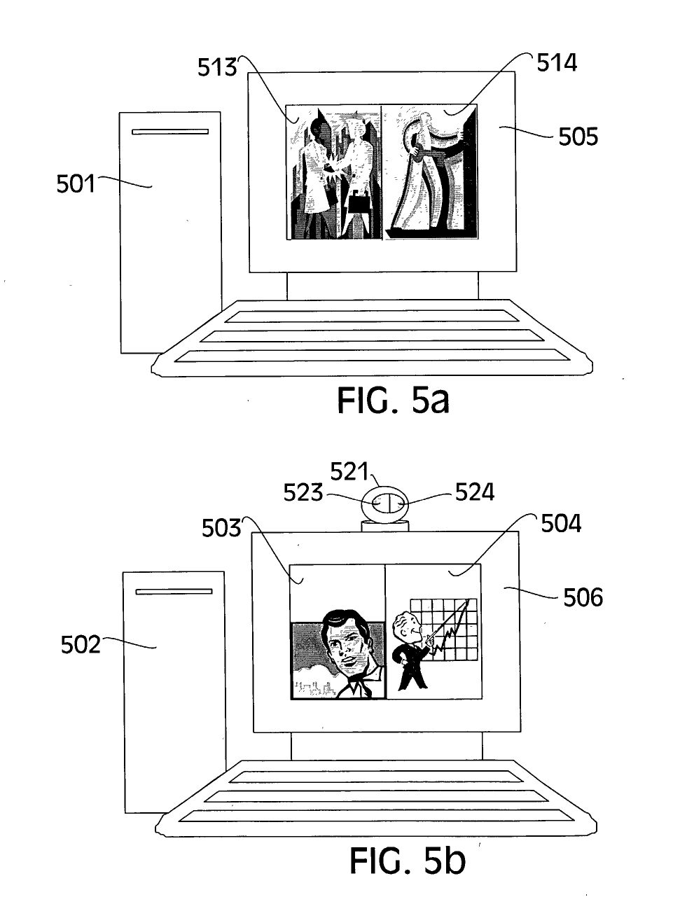

FIG. 5a illustrates one embodiment of a multifield image viewing system including processing logic 501 and display monitor 505. Processing logic 501 is operatively coupled with image sensors of a camera, for example camera 411, to generate independent digital images 513 and 514, for example from fields of view 413 and 414 respectively. Independent digital images 513 and 514 may be displayed concurrently on display monitor 505. The generation of independent digital images 513 and 514 by processing logic 501 (or by processing logic internal to camera 411 or by a combination of both) may optionally include but is not limited to independent rotational compensation, applying independent resolution settings and independent interpolative resampling.

FIG. 5b illustrates an alternative embodiment of a multifield image viewing system including, camera 521, processing logic 502 and display monitor 506. Camera 521 comprises lens portion 523 directed at one field of view and lens portion 524 directed at another field of view. Charge fields are collected in camera 521 and transferred to internal or external processing logic. Camera 421 may be a teleconferencing video camera for transmitting a presentation and a meeting discussion to a remote location.

Processing logic 502 is operatively coupled with image sensors of camera 521, to generate independent digital images 503 and 504. Independent digital images 503 and 504 may be displayed concurrently on display monitor 506. The generation of independent digital images 503 and 504 by processing logic 502 (or by processing logic internal to camera 521 or by a combination of both) may optionally include but is not limited to independent rotational compensation, applying independent resolution settings and independent interpolative resampling.

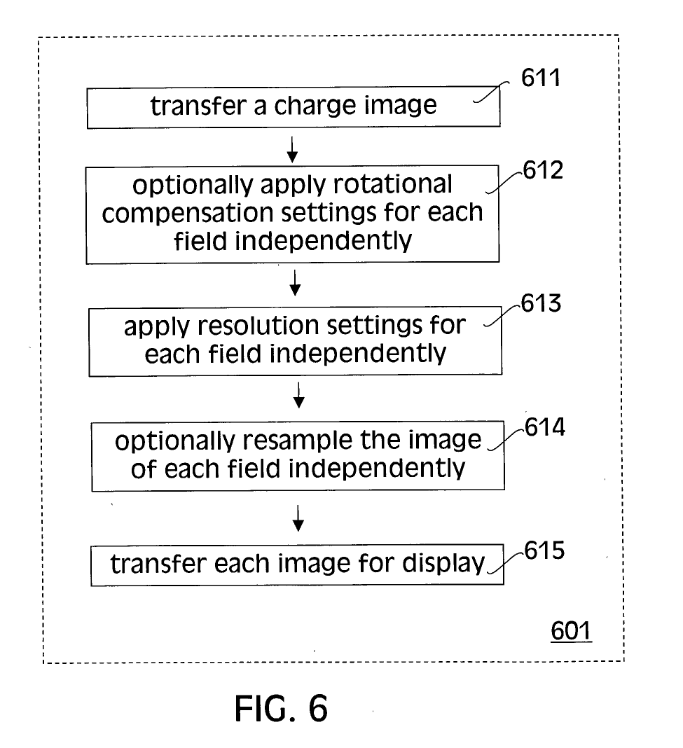

FIG. 6 illustrates a flow diagram for one alternative embodiment of a process to independently rotate and zoom multifield images. In processing block 611 one or more charge images having one or more fields are transferred for processing. Processing continues in processing block 612 where independent rotational compensation is optionally applied to each field. Processing continues in processing block 613 where independent resolution settings are applied for each field. Optionally, in processing block 614 each field is independently resampled or interpolated according to its respective resolution settings. It will be appreciated that such resampling and/or setting of independent resolutions provides for independent digital zooming of the fields. Finally in processing block 615 an image for each field is transferred for display.

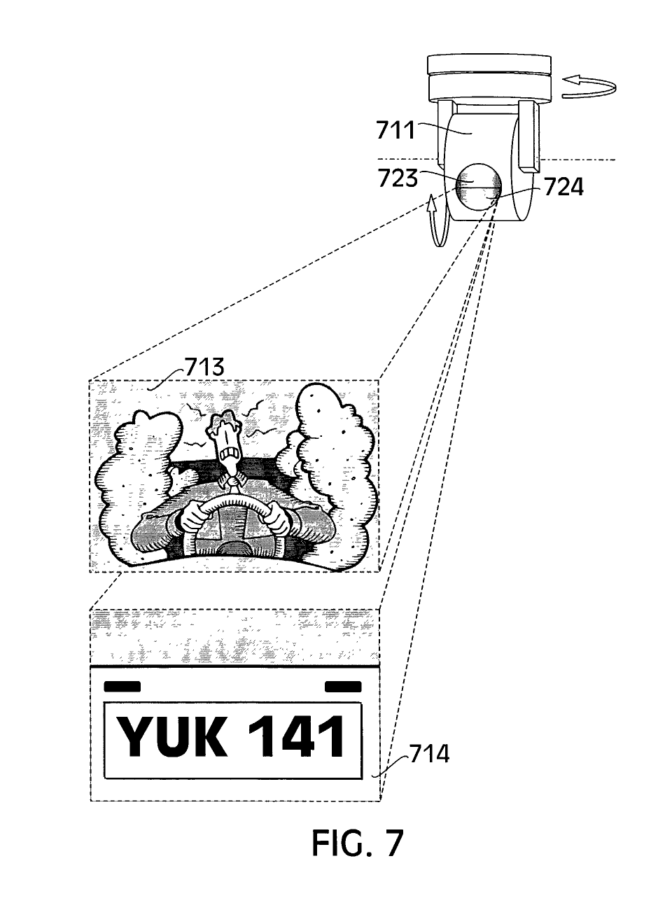

FIG. 7 illustrates, an alternative embodiment of a camera 711 for multifield image generation and processing. Camera 711 comprises lens portion 723 directed at field of view 713 and lens portion 724 directed at field of view 714. A charge image of field of view 713 is collected in camera 711 and transferred to internal or external processing logic. A charge image of field of view 714 is also collected in camera 711 and transferred to internal or external processing logic. Camera 711 may be a law enforcement camera for gathering evidence from field of view 713 and field of view 714. For one embodiment, camera 711 may be a still image camera to simultaneously record snapshots of traffic violators and their license plates. Independent images generated for field of view 713 and field of view 714 may be processed, printed and viewed at a location remote to camera 711. The generation of independent images for field of view 713 and field of view 714 by processing logic internal to camera 711 (or by processing logic external to camera 711 or by a combination of both) may optionally include but is not limited to applying independent resolution settings and independent interpolative resampling to zoom in on field of view 713 or to zoom in on field of view 714.

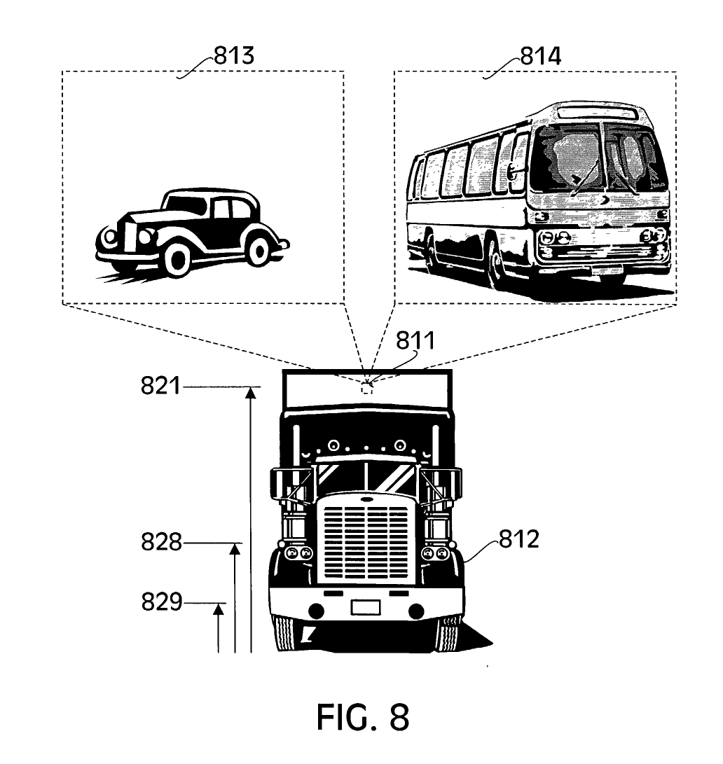

FIG. 8 illustrates an alternative embodiment of an apparatus 812 for multifield image generation and processing including, camera 811. Camera 811 comprises one lens portion directed at field of view 813 and another lens portion directed at field of view 814. Charge fields are collected in camera 811 and transferred to processing logic for concurrently displaying independent images of field of view 813 and of 814 to the operator of apparatus 812, for example on a dashboard display or on a heads-up display. For one embodiment of apparatus 812, camera 811 may be centrally positioned, facing substantially backwards from a height 821. For an alternative embodiment of apparatus 812, camera 811 may be positioned facing substantially backwards from a height 828 height 829. For another alternative embodiment of apparatus 812, camera 811 may be positioned facing substantially to one side or the other. It will be appreciated that apparatus 812 may represent a moving highway vehicle such as a car or truck or bus and that camera 811 may represent a digital “rearview mirror.” It will be further appreciated that apparatus 812 may represent a private or commercial vehicle such as an airliner or a ship and that camera 811 may represent a safety, or security or navigation camera.

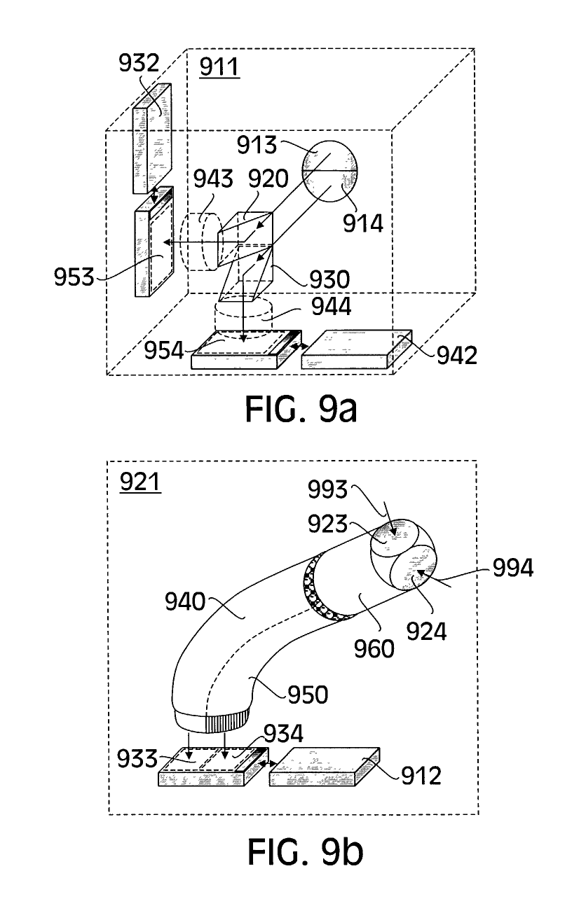

FIG. 9a illustrates, in detail, another alternative embodiment of an apparatus 911 for multifield image generation and processing. Apparatus 911 includes lens portion 913 directed at one field of view and lens portion 914 directed at another field of view. Image sensor area 953 collects a charge field of the first field of view from lens portion 913. Image sensor area 954 collects a charge field of the second field of view from lens portion 914. For one embodiment of apparatus 911, image sensor areas 953 and 954 each comprise a distinct image sensor CCD or CMOS device.

Apparatus 911 optionally includes one or more image guides. For example, prism 920 is physically coupled with and/or optically coupled with lens portion 913 and to sensor area 953 through optional optical device 943 to direct the first field of view from lens portion 913 to sensor area 953. Prism 930 is physically coupled with and/or optically coupled with lens portion 914 and to sensor area 954 through optional optical device 944 to direct the second field of view from lens portion 914 to sensor area 954. Optional optical devices 943 and 944 may perform optical zooming or filtering to remove aberrations, for example, such as spherical aberrations or chromatic aberrations. Processing logic 932 is coupled with image sensor area 953 and processing logic 942 is coupled with image sensor area 954 to generate independent digital images from the charge fields collected by sensor areas 953 and 954. It will be appreciated that processing logic 932 and processing logic 942 may optionally provide for digital zooming and resampling in lieu of or in addition to optical devices 943 and 944.

FIG. 9b illustrates, in detail, another alternative embodiment of an apparatus 921 for multifield image generation and processing. Apparatus 921 includes lens portion 923 directed in a distinct direction 993 and lens portion 924 directed in another distinct direction 994. Image sensor area 933 collects a charge field focused by lens portion 923 of a scene in the distinct direction 993. Image sensor area 934 collects a charge field focused by lens portion 924 of a scene in the distinct direction 994.

For one embodiment lens portion 923 and lens portion 924 may be part of an endoscope objective 960. Apparatus 921 optionally includes flexible image guides 940 and 950. For example, image guide 940 may comprise fiber optics or a rod lens system optically coupled with lens portion 923 to direct the first scene focused by lens portion 923 to sensor area 933, and image guide 950 may comprise fiber optics or a rod lens system optically coupled with lens portion 924 to direct the second scene focused by lens portion 924 to sensor area 934. Processing logic 912 is coupled with image sensor areas 933 and 934 to generate independent digital images from the charge fields collected by sensor areas 933 and 934. The generation of each independent digital image by processing logic 912 may optionally include filtering of the respective charge field, for example, to remove Moiré interference patterns related to fiber optic image guides.

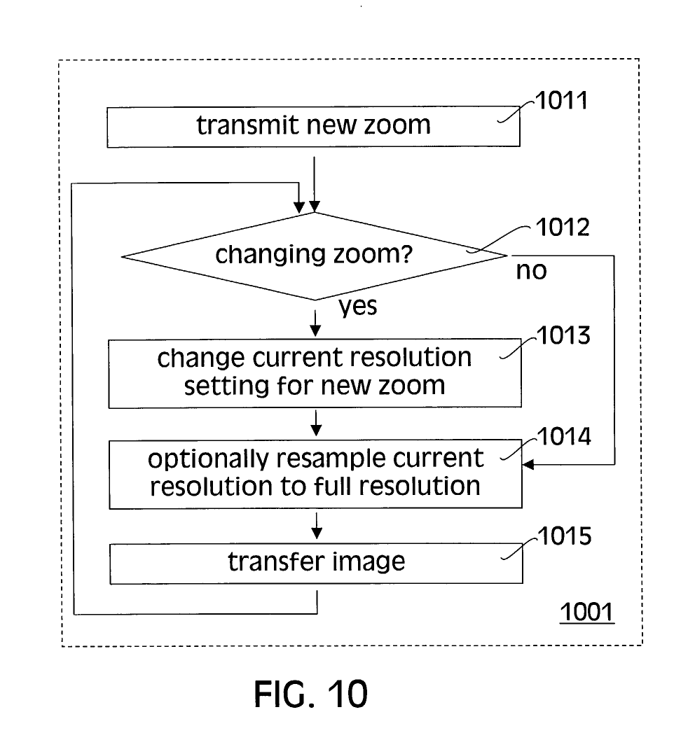

FIG. 10 illustrates a flow diagram for one embodiment of a process 1001 to zoom and optionally resample an image. In processing block 1011 a new zoom is transmitted. Processing continues in processing block 1012 where a check is performed to identify a changing zoom. If the zoom is changing, then processing proceeds to processing block 1013 where the current resolution setting is changed in accordance with the new zoom and processing continues in processing block 1014. Otherwise processing proceeds directly to processing block 1014 where the field is optionally resampled, for example, through bilinear interpolations, to restore full resolution. Processing then proceeds to processing block 1015 where the image is transferred. Processing then resumes again in processing block 1012. It will be appreciated that process 1001 may thus provide for independent digital zooming of multifield images.

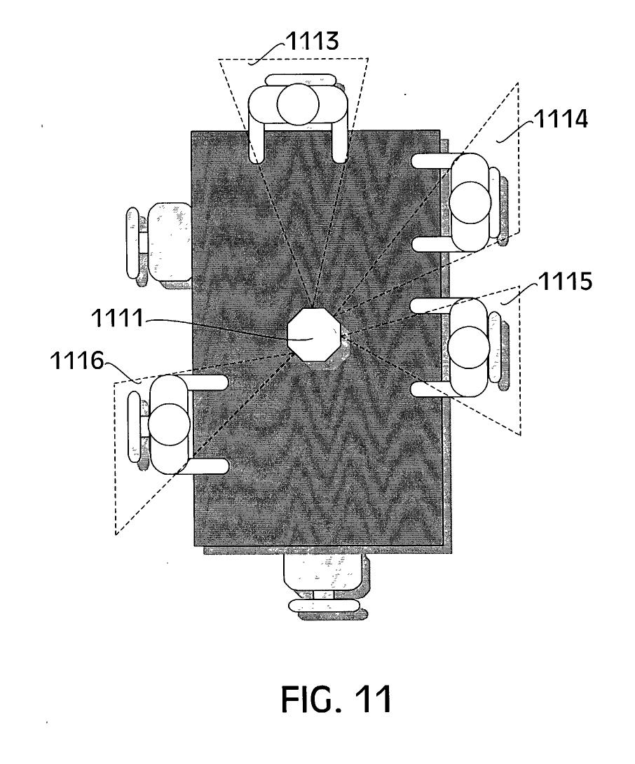

FIG. 11 illustrates, another alternative embodiment of a camera 1111 for multifield image generation and processing. Camera 1111 comprises a first lens portion directed at field of view 1113, a second lens portion directed at field of view 114, a third lens portion directed at a field of view 1115 and a fourth lens portion directed a field of view 1116. Charge images of fields of view 1113, 1114, 1115 and 1116 arel collected in camera 111 and transferred to processing logic to generate independent digital images from the charge fields for analysis and/or display.

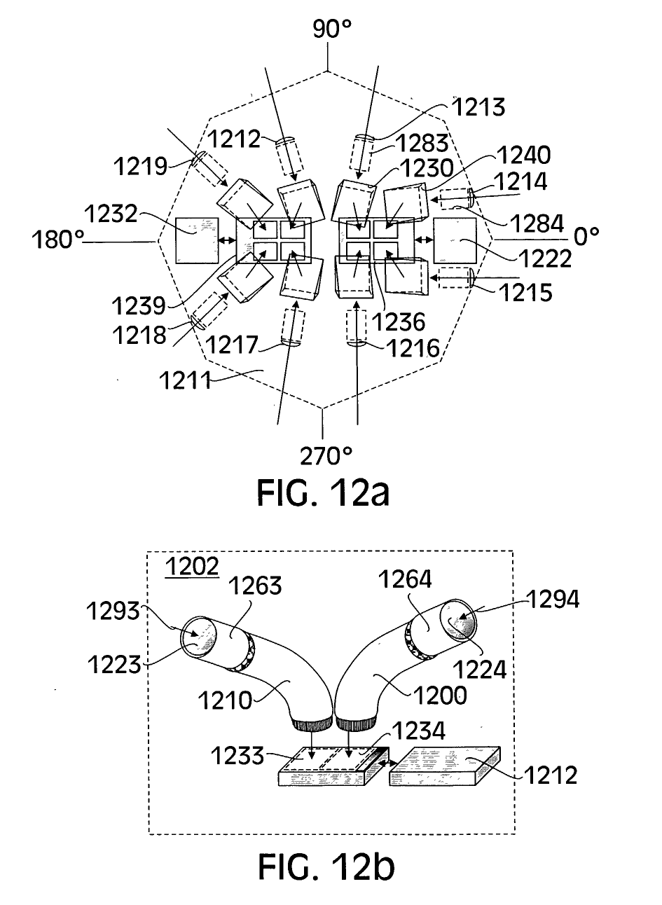

FIG. 12a illustrates, in detail, one embodiment of a camera 1211 of FIG. 11. Camera 1211 includes lens portions 1212-1219 each directed at a distinct scene in a distinct direction. Image sensor 1236 comprises image sensor areas for collecting a charge field from lens portions 1213, 1214, 1215 and 1216. Image sensor 1239 comprises image sensor areas for collecting a charge field from lens portions 1212, 1217, 1218 and 1219. Camera 1211 optionally includes one or more image guides pivotally displaceable about sensor areas of sensors 1236 and 1239. For example, prism 1230 is physically coupled with or optically coupled with lens portion 1213 through pivotally displaceable path 1283 to direct the first scene focused by lens portion 1213 to a first sensor area of sensor 1236, and prism 1240 is physically coupled with or optically coupled with lens portion 1214 through pivotally displaceable path 1284 to direct the second scene focused by lens portion 1214 to a second sensor area of sensor 1236. It will be appreciated that one of lens portions 1213 and 1214 may be directed in substantially any distinct direction between zero and ninety degrees (indicated as 0°-90°). Similarly, one of lens portions 1215 and 1216 may be directed in substantially any distinct direction between two hundred seventy and three hundred sixty degrees (indicated as 270°-0°). Likewise, one of lens portions 1217 and 1218 may be directed in substantially any distinct direction between one hundred eighty and two hundred seventy degrees (indicated as 180°- 270°) and one of lens portions 1219 and 1212 may be directed in substantially any distinct direction between ninety and one hundred eighty (indicated as 90°-180°).

Processing logic 1222 is coupled with the sensor areas of image sensor 1236 and processing logic 1232 is coupled with the sensor areas of image sensor 1239 to generate independent digital images from the charge fields collected by sensor areas of image sensors 1236 and 1237. The generation of each independent digital image by processing logic 1222 and 1232 may optionally include rotational compensation of the respective charge field.

FIG. 12b illustrates, in detail, another alternative embodiment of an apparatus 1202 for multifield image generation and processing. Apparatus 1202 includes lens 1223 directed in a distinct direction 1293 and lens 1224 directed in another distinct direction 1294. Image sensor area 1233 collects a charge field focused by lens 1223 of a scene in the distinct direction 1293. Image sensor area 1234 collects a charge field focused by lens 1224 of a scene in the distinct direction 1294. It will be appreciated that directions 1293 and 1294 may vary vertically or horizontally.

For one embodiment lens 1223 and lens 1224 may be part of objectives 1263 and 1264 respectively. Apparatus 1202 optionally includes flexible image guides 1210 and 1200 pivotally displaceable about sensor areas 1233 and 1234 respectively. For example, image guide 1210 may comprise fiber optics or a rod lens system optically coupled with lens 1223 to direct the first scene focused by lens 1223 to sensor area 1233, and image guide 1200 may comprise fiber optics or a rod lens system optically coupled with lens portion 1224 to direct the second scene focused by lens portion 1224 to sensor area 1234. Processing logic 1212 is coupled with image sensor areas 1233 and 1234 to generate independent digital images from the charge fields collected by sensor areas 1233 and 1234. The generation of each independent digital image by processing logic 1212 may optionally include independent rotational compensation, independent zooming and resampling, and filtering of the respective charge field, for example, to remove Moiré interference patterns related to fiber optic image guides.

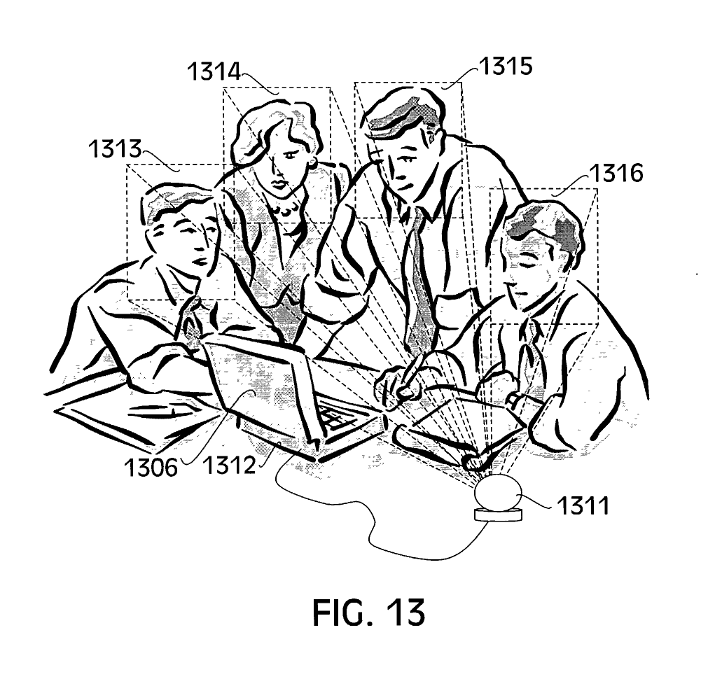

FIG. 13 illustrates another alternative embodiment of a system for multifield image generation, processing and viewing including, camera 1311, processing logic 1312 and display monitor 1306. Camera 1311 comprises at least four of lens portions directed at fields of view 1313, 1314, 1315 and 1316 in at least four distinct directions. It will be appreciated that the four distinct directions may vary vertically or horizontally. Charge fields are collected in camera 1311 and transferred to internal and/or to external processing logic 1312. Camera 1311 may be a teleconferencing video camera, for example, for transmitting a meeting discussion to a remote location.

Processing logic 1312 is operatively coupled with image sensors of camera 1311, to generate independent digital images to be displayed concurrently on display monitor 1306. The generation of the independent digital images by processing logic 1312 (or by processing logic internal to camera 1311 or by a combination of both) may optionally include but is not limited to independent rotational compensation, applying independent resolution settings, independent interpolative resampling and filtering.

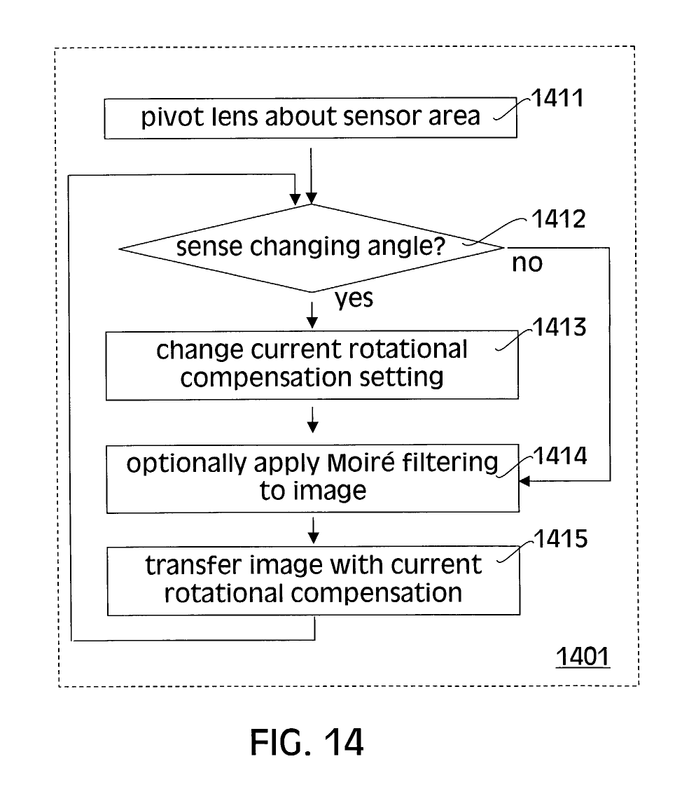

FIG. 14 illustrates a flow diagram for an alternative embodiment of a process 1401 to rotationally compensate and optionally filter an image. In processing block 1411 a lens is pivoted (manually or mechanically) about a sensor area. In processing block 1412, a changing of the angle for a field of view is potentially sensed. If a change of angle is sensed processing continues in processing block 1413 where the current rotational computation setting is changed and processing continues in processing block 1414 where an image is optionally filtered to remove Moiré interference patterns related to fiber optic image guides. Then in processing block 1415 the image is transferred with the new rotational setting.

Otherwise, if no change of angle is sensed, processing continues in processing block 1414 where the image is optionally filtered to remove Moiré interference patterns and then transferred with the original rotational setting in processing block 1415.

Processing then resumes again in processing block 1412.

It will be appreciated that process 1401 may be used in conjunction with an apparatus for multifield image generation, for example camera 1311, camera 1211 or apparatus 1233 to provide high quality independent images for multiple distinct scenes.

The above description is intended to illustrate preferred embodiments of the present invention. From the discussion above it should also be apparent that especially in such an area of technology, where growth is fast and further advancements are not easily foreseen, the invention may be modified in arrangement and detail by those skilled in the art without departing from the principles of the present invention within the scope of the accompanying claims and their equivalents.

What is claimed is:

1. A method comprising:
sensing an angular change in an image field of a first image sensor area of a plurality of image sensor areas; and
applying a rotational compensation to the image field of the first image sensor area independent of other sensor areas of the plurality of image sensor areas.

2. The method of claim 1 further comprising:
applying a resolution setting to the image field of the first image sensor area independent of other sensor areas of the plurality of image sensor areas; and
optionally resampling the image field of the first image sensor area independent of other sensor areas of the plurality of image sensor areas.

3. The method of claim 2 further comprising:
transferring the image field with rotational compensation for independent concurrent display with an image field of a second image sensor area of the plurality of image sensor areas in the camera, the second image sensor area different from the first image sensor area.

4. An article of manufacture comprising
a machine-accessible medium including data that, when accessed by a machine, cause the machine to perform the method of claim 2.

5. The method of claim 1 further comprising:
optionally applying a Moiré filter to the image field of the first image sensor area independent of other sensor areas of the plurality of image sensor areas; and
transferring the image field with rotational compensation for concurrent display with an image field of a second image sensor area of the plurality of image sensor areas in the camera, the second image sensor area different from the first image sensor area.

6. The method of claim 1 further comprising:
manually pivoting a lens about the first image sensor area.

7. The method of claim 1 further comprising:
pivoting a lens about the first image sensor area under mechanized control.

8. An article of manufacture comprising
a machine-accessible medium including data that, when accessed by a machine, cause the machine to perform the method of claim 1.

9. A camera comprising:
a first lens portion directed at a first field of view;
a first image sensor area to collect a first charge field of the first field of view;
a second lens portion directed at a second field of view different from the first field of view;
a second image sensor area to collect a second charge field of the second field of view;
processing logic coupled with the first and second image sensor areas to generate a first digital image from the first charge field and a second digital image from the second charge field; and
a storage medium coupled with the processing logic to store the first digital image and to store the second digital image separate from the first digital image.

10. The camera of claim 9 wherein the first and second lens portions are portions of a single lens assembly.

11. The camera of claim 10 wherein the first and second image sensor areas each comprise a distinct image sensor.

12. The camera of claim 9 wherein the first and second lens portions each comprises a distinct lens.

13. The camera of claim 12 wherein the first and second lens portions each comprises a distinct compound lens.

14. The camera of claim 12 wherein the first and second image sensor areas are two portions of a single image sensor area.

15. A camera comprising:
a plurality of lenses directed at a plurality of independent fields of view;
one or more image sensors to collect a charge field of each of the plurality of independent fields of view; and
processing logic coupled with the one or more image sensors to generate an independent digital image from the charge field collected of each of the plurality of independent fields of view.

16. The camera of claim 15 further comprising:
image guides to transmit the plurality of independent fields of view to the one or more image sensors.

17. The camera of claim 16 wherein the plurality of lenses comprises an endoscope objective.

18. The camera of claim 15 wherein each of the plurality of lenses comprises a compound lens.

19. The camera of claim 15 wherein charge fields of a plurality of independent fields of view are collected by one of the one or more single image sensors.

20. The camera of claim 19 wherein the charge field of each of the plurality of independent fields of view is collected by the same image sensor.

21. An apparatus comprising:
a plurality of lenses configurable in a plurality of distinct directions, each lens to focus a scene from one of the plurality of distinct directions;
a plurality of image sensor areas, each to collect a charge field of scene focused by one of the plurality of lenses; and
processing logic coupled with the plurality of image sensor areas to process an independent digital image each charge field collected by the plurality of image sensor areas.

22. The apparatus of claim 21 wherein the plurality of lenses comprises an endoscope objective.

23. The apparatus of claim 22 wherein the plurality of image sensor areas each comprise a distinct image sensor.

24. The apparatus of claim 21 wherein each of the plurality of lenses comprises a distinct compound lens.

25. The apparatus of claim 24 further comprising:
image guides to transmit the plurality of independent fields of view to the one or more image sensors.

26. The apparatus of claim 24 wherein at least two of the plurality of image sensor areas are portions of a single image sensor.

27. An apparatus comprising:
a plurality of image collectors;
first means for guiding a plurality of distinct scenes, each from a distinct directions, to the plurality of image collectors; and
second means coupled with the plurality of image collectors for processing an independent image for each of the plurality of distinct scenes.

28. The apparatus of claim 27 wherein at least two of the plurality of image collectors are portions of a single charged couple device (CCD) sensor.

29. The apparatus of claim 27 wherein at least two of the plurality of image collectors are portions of a single complementary metal oxide semiconductor (CMOS) sensor.

30. An apparatus comprising:
a plurality of image collectors;
a plurality of image guides to guide a plurality of distinct scenes, each from a distinct directions, to the plurality of image collectors; and
processing logic coupled with the plurality of image collectors to process an independent image for each of the plurality of distinct scenes.

31. The apparatus of claim 30 wherein at least two of the plurality of image collectors are portions of a single charged couple device (CCD) sensor.

32. The apparatus of claim 30 wherein at least two of the plurality of image collectors are portions of a single complementary metal oxide semiconductor (CMOS) sensor.

33. An image viewing system comprising:
a camera having a plurality of image sensor areas to collect a charge field for each of a plurality of distinct scenes;
processing logic operatively coupled with the plurality of image sensor areas to process an independent digital image for each charge field collected by the plurality of image sensor areas; and
one or more monitors to concurrently display a plurality of the independent images processed.

34. The image viewing system of claim 33 wherein the processing logic comprises a digital computer external to the camera.

35. The image viewing system of claim 33 wherein the processing logic comprises a finite state machine internal to the camera.

36. The image viewing system of claim 33 wherein the processing logic comprises both a digital computer external to the camera and a finite state machine internal to the camera.

37. The image viewing system of claim 33 wherein the one or more monitors are to display the plurality of independent images to the operator of a moving vehicle.

38. The image viewing system of claim 33 wherein the one or more monitors are to receive the plurality of independent images at a location, remote with respect to the camera.

39. The image viewing system of claim 38 wherein the camera is a security camera for monitoring the plurality of distinct scenes from a secured area.

40. The image viewing system of claim 38 wherein the camera is a law enforcement camera for monitoring the plurality of distinct scenes to gather evidence.

41. The image viewing system of claim 38 wherein the camera is a videoconferencing camera.

42. The image viewing system of claim 33 wherein the plurality of independent images are motion video images.

43. The image viewing system of claim 33 wherein the plurality of independent images are still images.
